(19) United States
(12) Patent Application Publication
(10) Pub. No.: US 2016/0091882 A1
(43) Pub. Date: Mar. 31, 2016

(54) SYSTEM AND METHOD OF MULTI-CORE BASED SOFTWARE EXECUTION FOR PROGRAMMABLE LOGIC CONTROLLERS

(71) Applicant: Siemens Aktiengesellschaft, Munich (DE)

(72) Inventors: Hartmut Ludwig, West Windsor, NJ (US); Phani Ram Kumar Kuruganty, East Windsor, NJ (US); Kun Ji, Plainsboro, NJ (US); Florian Ersch, Plainsboro, NJ (US)

(21) Appl. No.: 14/499,715

(22) Filed: Sep. 29, 2014

(51) Int. Cl. G05B 19/05

(52) U.S. Cl. CPC G05B 19/054; G05B 2219/2205; G05B 2219/1105

(57) ABSTRACT

Real-time programmable logic controller software is executed on a multicore processor system. An organizational block executer is executed on a first core, and system service functions associated with the programmable logic controller software are executed on the second core. The organizational block executer includes I/O scanning and logic solving in a single-threaded execution. Core-switch operations may be cyclically performed to move execution of the organizational block executer from the first core to the second core and back to the first core.

### BACKGROUND OF THE INVENTION

1. Field of the Invention

The invention relates generally to programmable logic controllers. More specifically, the invention addresses the execution of a programmable logic controller application program on a multiprocessor or multicore processor system.

2. Description of the Prior Art

An industrial control system often includes a programmable logic controller (PLC) for providing coordinated control of industrial control equipment, which includes various elements that are often either sensors for providing inputs to the PLC, or relays for receiving outputs from the PLC, each under the control of an element controller, and each connected to the PLC over a network via a network I/O device. A PLC generally has a processor, a memory, and a number of separate input/output (I/O) modules coupled to the control equipment. The processor is the heart of the PLC and responsible for many PLC functions, such as input scanning, logic solving and output scanning.

As the complexity of industrial systems has increased, the associated PLCs have evolved to utilize embedded software for the coordination of the requisite high-volume and high-precision manufacturing. Industries such as pharmaceutical, chemical, energy and others rely on PLCs that are utilized for sensing, planning complex processes and actuating thousands of times per second through high-speed cameras, light sensors, collision avoidance and detection, robotic devices, motors and the like. These PLCs must not only comply with hard real-time requirements, but must also be able to survive in extreme environments of temperature, pressure, vibration and humidity, while remaining operable for decades without interruption or failure. Throughout the years, embedded software for PLCs has been developed by non-computer experts using domain-specific languages that have been designed and refined by experienced practitioners, manufacturers of automation hardware and software, as well as independent institutions from different industry sectors.

The IEC 61131-3 standard has been widely adopted as the programming standard for PLCs since about 1993, but its languages have been used since the early 1970's. The standard provides a total of five different languages: two textual languages (Instruction List or IL, and Structured Text or ST), two graphical languages (Ladder Diagram or LD, and Function Block Diagram or FBD) and one with both textual and graphical representations (Sequence Function Chart or SFC). Different industry sectors use different languages, or combinations of them, simply because each language has special semantics that facilitate certain automation tasks. These programming languages have been designed to satisfy the needs and increase the productivity of non-computer experts such as electrical, mechanical and chemical engineers.

Flexibility is one of the most important features in industrial PLCs inasmuch as the production requirements change significantly between different products, or different generations of the same product. Therefore, there is an economical and technical motivation to shift from custom architectures and programming languages into flexible off-the-shelf architectures and standardized automation languages.

The program logic of a typical PLC is structured in organization blocks (OB) that contain program code for processing input signals and generating output signals to control peripheral devices. The organization blocks are executed sequentially by a single task, which is referred to as the OB Executer. The OB Executer runs cyclically in an infinite loop, where in each cycle the OB Executer schedules and executes organizational blocks and reads and writes data accordingly. The cycled sequence is typically READ-EXECUTE-WRITE, wherein the core PLC functions are performed: I/O functions for reading and writing data, and execute functions for processing data. The OB Executer is attached to a Timer that is executed in a separate task. The timer is used to enable sleep periods after each cycle, which is necessary to create breaks in the execution of the OB Executer to allow lower-priority tasks to execute on the processor.

Because of the real-time, sequential nature and physical world interconnections of a PLC application program, PLC software is generally written as a single-threaded, sequential set of instructions. One example of a PLC is a PLC instantiated in the Siemens Windows Automation Control (WinAC®) software controller for personal computer (PC)-based automation solutions. Such a PLC permits real-time capable, deterministic control functions. In the case of a PLC running on the WinAC® platform, the OB executer runs as the OBExecuter class.

The adoption of multi-core processors appears to be the next evolutionary step in high-performance control systems, since they offer better energy efficiency, redundancy, consolidation properties and scalable performance than existing systems. Unfortunately, as of today, there is only a very limited understanding on how to execute PLC software in multi-core processors. Attempts have included efforts to allocate various PLC functions such as I/O scanning and logic solving to different processors to run in parallel. That allocation requires complex data coordination between the parallel processes. Further, such attempts have not necessarily resulted in an even load distribution among the processors.

On the other hand, exploiting multi-core based application execution in PLC systems can gain significant improvements regarding not only performance specifics such as latency, response-time, and load balancing, but also other non-functional characteristics, such energy efficiency and durability.

A need therefore exists for a technique for allocating resources in a multi-core environment to execute sequential PLC application programs.

A further need exists in the art for maintaining the sequential and single-threaded nature of a PLC application program while executing in and benefiting from a multi-core environment.

Another need exists in the art for the optimization of a multiprocessing scheme for executing a PLC application program in a multi-core environment.

A further need remains for an improved methodology for implementing PLC programs in a multi-core processor environment without excessive complexity.

An additional need exists in the art to allocate PLC tasks among the cores of a multi-core processor environment in a way to evenly distribute the workload among the processors.

### SUMMARY OF THE INVENTION

The needs remaining in the prior art are addressed by the present invention, which relates to the execution of a programmable logic controller application program on multi-core processor systems.

Exemplary embodiments of the invention feature a method for executing real-time programmable logic controller software on a multi-core processor computer system including at least a first core and a second core. The method comprises executing an organizational block executer on the first core, the organizational block executer comprising I/O scanning and logic solving in a single-threaded execution. The method further comprises, concurrently with executing the organizational block executer on the first core, executing system service functions associated with the programmable logic controller software on the second core.

Core-switch operations may be cyclically performed to move execution of the organizational block executer from the first core to the second core and back to the first core. In that case, the system service functions are executed on the second core when the organizational block executer is executing on the first core, and are executed on the first core when the organizational block executer is executing on the second core. The organizational block executer may be executed between core switch operations without sleep time.

Other exemplary embodiments of the invention feature a programmable logic controller for executing real-time programmable logic controller software. The programmable logic controller comprises a multicore processor having at least a first core, a second core and computer readable media connected to the processor. The computer readable media contains computer readable instructions that, when executed by the processor, cause the processor to perform operations including executing an organizational block executer on the first core, the organizational block executer comprising I/O scanning and logic solving in a single-threaded execution. The instructions further cause the processor to, concurrently with executing the organizational block executer on the first core, executing system service functions associated with the programmable logic controller software on the second core.

The respective objects and features of the exemplary embodiments of the invention may be applied jointly or severally in any combination or sub-combination by those skilled in the art.

### BRIEF DESCRIPTION OF THE DRAWINGS

The invention is explained in more detail with reference to an exemplary embodiment illustrated in a drawing, in which:

FIG. 1 is a time chart showing operations of a state-of-the-art PLC on a single processor.

FIG. 2 is a schematic block diagram showing a PLC and environs according to embodiments of the present disclosure.

FIG. 3 is a time chart showing operations of a PLC according to embodiments of the present disclosure.

FIG. 4 is a time chart showing operations of a PLC according to embodiments of the present disclosure.

FIG. 5 is a pseudo code listing showing instructions for core switch setup according to embodiments of the present disclosure.

FIG. 6 is a time chart showing operations of a PLC according to embodiments of the present disclosure.

FIG. 7 is a flow chart showing a method according to embodiments of the present disclosure.

FIG. 8 is a bar chart comparing OB workloads of several PLCs including PLCs according to embodiments of the present disclosure.

Like parts are labeled with the same reference signs in all the figures.

### DETAILED DESCRIPTION

Most state-of-the-art computing systems rely on multiprocessor systems. High performance computing systems have done so for several decades, and even embedded computing systems have, for a number of years, been using multiple processors. There remain challenges in implementing multi-core systems, ranging from automated testing, verification of parallel software, performance optimization, system scalability and software engineering processes.

No known PLC system fully utilizes multiprocessor technology. The execution of the application program in a multiprocessor PLC system still occurs on one processor. The application program execution task therefore binds to a single processor, so the execution load is not well balanced among the processors. There is no execution load distribution among the processors.

Disclosed herein is a method and system for executing a PLC application program on a multiprocessor system. Embodiments of the disclosure are described with reference to the migration of a mobility train controller executing in WinAC®, a software-based PLC, to a multiprocessor-based application program execution system. The resulting two-core PLC system runs on vxWorks® SMP, a real-time multi-core operating system available from Wind River Systems of Alameda, Calif. Two multi-core based task execution strategies are proposed to enable load-balancing of the application execution work load.

Several important goals are realized by the described system and method. The system has a maximum compatibility with presently available systems, minimizing implementation costs. For example, no changes are required to present PLC applications in order to implement the described multi-core system. No parallelization is required of PLC Organization Blocks, and the single-threaded PLC programming model is preserved. Only minimal changes to the PLC execution model are required, with coarse-grained parallelization.

Implementation of the described system results in increased speed. For example, the system enables load-balancing to distribute the computing load across the processors. The PLC scan rate is increased. The PLC response time is reduced, reducing latency.

The presently described multi-core system has improved stability as compared with present systems. By enabling load-balancing, the system is able to distribute heat dissipation which increases the reliability and durability of the processors.

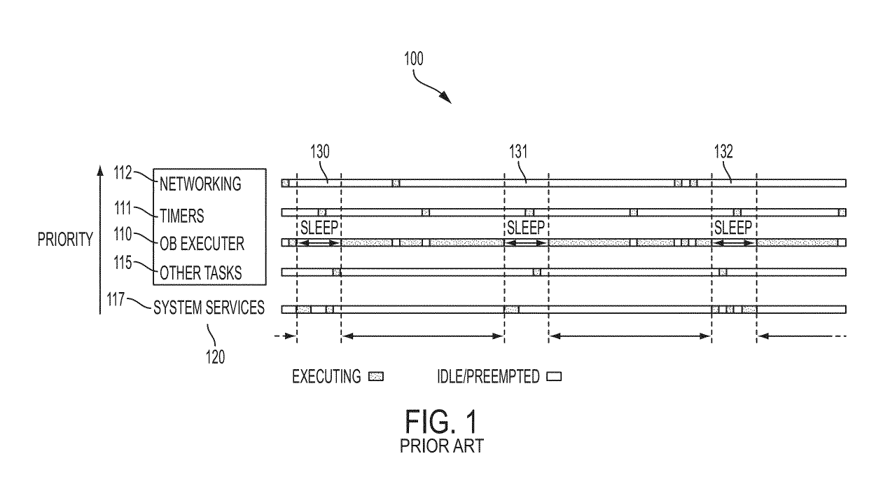

For clarity, the basic operation of a state of the art PLC will first be described with reference to the timing chart 100 of FIG. 1. The program logic of a PLC, such as a software-based PLC executing in WinAC®, is structured in organization blocks (OB) that contain program code for processing input signals and transmitting output signals to control peripheral devices. As noted above, the organization blocks are executed sequentially by a single task, which is referred to as the OB Executer. A timer that is executed in a separate task is used to mandate sleep periods after each cycle, for executing tasks having a lower priority than the OB Executer task.

Current state-of-the-art PLC systems use only one processor to run the OB Executer task. As shown in the timing chart 100 of FIG. 1, the task execution model in state-of-the-art PLC is a single-threaded execution model of OBs, in which the OB Executer 110 performs an infinite loop of OB execution. Tasks having a higher priority than the OB Executer 110, such as networking 111 and the timers 112, can preempt the OB Executer 110 and can execute at any time. Tasks having a lower priority than the OB executer 110, such as the “other tasks” 115 and system services 117, can execute only during sleep periods such as periods 130, 131, 132. The system services tasks may include tasks such as safety-related tasks, HMI, software update operations, Web service tasks and management-related tasks. For example, in the case of a train mobility controller application, the PLC performs several safety-related tasks that must be performed during sleep periods of the OB executer.

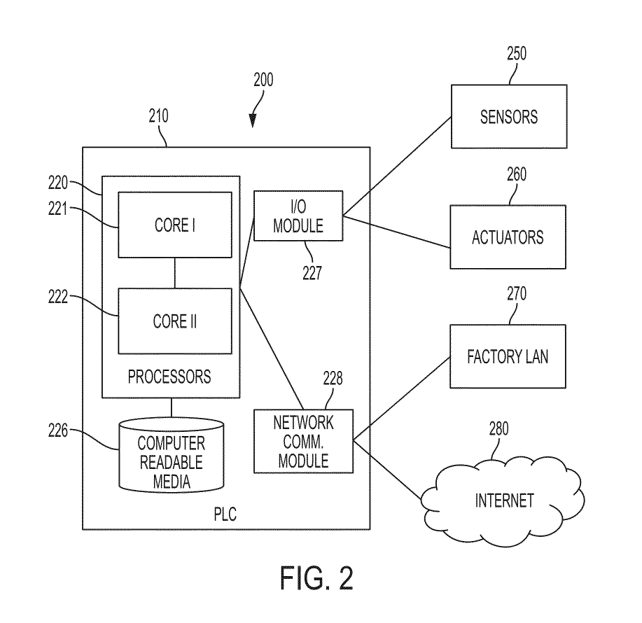

An example PLC system 200 and its environs are shown in FIG. 2. The system includes a PLC 210 that may be a dedicated hardware element or may be a PC running PLC software such as WinAC®. The PLC comprises a processor 220 including at least a first core 221 and a second core 222. The present disclosure presents embodiments with reference to a multi-core processor, as shown in FIG. 2, and also with reference to a multiprocessor system in which separate processors run in parallel. The systems and methods of the disclosure may be implemented with either architecture.

The multicore processor 220 communicates with computer readable media 226 that may store computer useable instructions for carrying out the systems and methods of the disclosure. The computer readable media 226 may additionally be used for data storage and for other storage purposes.

The multicore processor 220 additionally communicates with I/O module 227 and network communications module 228, which may both be components of the PLC 210. The I/O module 227, in turn, performs controller communication tasks such as reading sensors 250 and moving actuators 260. The network communications module 228 communicates with a factory LAN 270 or another automation LAN, and may also have a connection to the Internet 280. The network communication module 228 is used by the PLC in performing HMI tasks, software updates, remote Web services, etc.

In order to gain optimal processor utilization, the various embodiments of the present disclosure bind tasks to certain processors or cores. As with other Linux® based operating systems, VxWorks® SMP provides that capability in terms of processor affinities. This enables a programmer to specify for each task a set of processors that can eventually be used to execute that task. Based on this feature, following three strategies are proposed in this invention.

Dedicated Cores Strategy

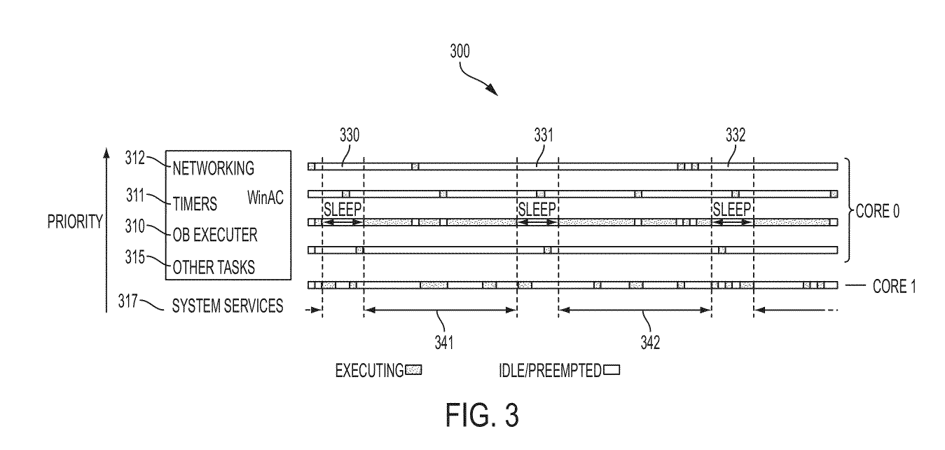

Embodiments executing PLC software using dedicated cores in a multicore environment is depicted in the timing chart 300 of FIG. 3. In that strategy, the OB executer 310 and other WinAC® tasks are specified to be executed in one core or processor (CORE 0). The other WinAC® tasks include networking 312 and timers 311, as well as other tasks 315. Non-WinAC® tasks (including system services 317) are specified to be executed in the other core or processor (CORE 1). As an embodiment using the vxWorks® operating system, the dedicated cores execution strategy can be easily implemented by using the taskCpuAffinitySet( ) API at the time a task is created.

In the presently described embodiment using dedicated cores, no changes to WinAC® execution mode are required. OB execution remains single-threaded, with all WinAC® tasks pinned to core 0. All WinAC® tasks of the OB Executer execute in a single-core execution.

As noted, all other tasks, including System Services, are pinned to core 1. As can clearly be seen in FIG. 3, systems services tasks 317 may execute at any time during both the sleep periods 330, 331, 332 and the periods 341, 342 during which the OB Executer is executing.

Ping-Pong Strategy

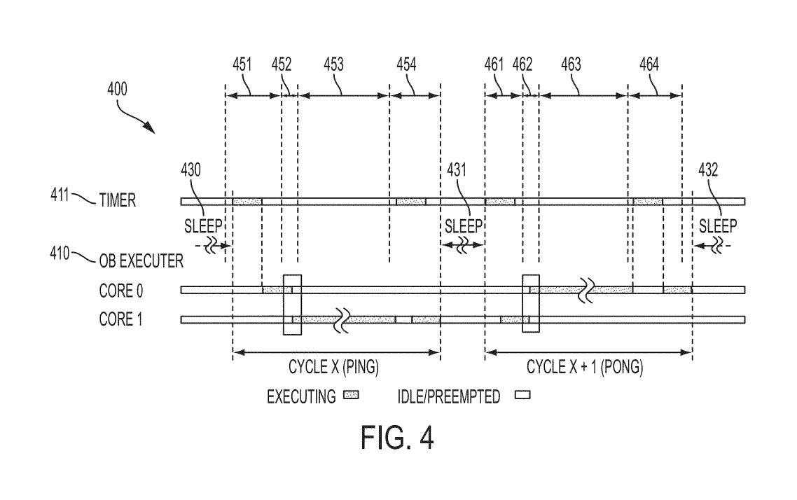

An execution strategy is now described, with reference to the time chart 400 of FIG. 4, in which the OB Executer task cyclically executes on alternating cores to further improve load balancing. In this arrangement, the OB Executer runs alternately on both core 0 and core 1. Each cycle (“ping” and “pong”) includes several phases in which the timer 411 and OB Executer 410 perform certain tasks.

In a wake-up phase 451 of the “ping” cycle, the timer 411 signals the OB executer 410 to return on-line after a sleep phase 430. In a core-switch phase 452, execution of the OB Executer is moved from core 0, where the previous cycle had been executed, to core 1. In an OB execution phase, the OB Executer executes on core 1. In a timer set-up phase 454, the timer performs reset and other functions to prepare for the next cycle. A sleep phase 431 of the OB Executer begins immediately after the timer set-up phase 454.

The next cycle is a “pong” cycle in which the OB Executer 410 switches to and executes on core 0. The cycle phases again include a wake-up phase 461, a core-switch phase 462, an OB execution phase 463 and a timer set-up phase 464. After the next sleep cycle 432, the system returns to another “ping” cycle in which the OB Executer executes on core 1.

Only minor, “surgical” changes to the OB Executer are necessary to implement the “ping-pong” arrangement discussed above. Those changes are needed to cause the OB Executer to alternate cores in each cycle. The OB execution remains a single-threaded process.

Implementation of the “ping-pong” arrangement results in roughly equal load balancing of the cores. Load balancing between the cores results in more even energy consumption and heat generation, increasing the average life of the processor. No changes are necessary to other WinAC® tasks. Tasks that have higher priority than the OB Executer may remain executing on the same core as the OB Executer, interrupting execution of the OB Executer as needed. Alternatively, those higher-priority tasks may run on the other core, so as not to affect execution of the OB Executer. System services and other non-WinAC® tasks can run at any time on either of the cores.

In the case in which a PLC is instantiated in the WinAC® PLC software, the core-switch is implemented in DoUpdateInputs function of the OBExecuter class. The core-switch can be enabled and disabled with the following macros (define-primitives of the pre-compiler). While the examples show cores alternating every cycle, the cores could alternate less often, such as every other cycle or every third cycle, while remaining within the scope of the disclosure. Less frequent core switches may be used in cases where there are significant costs associated with the core switches. The following are exemplary macros:

MP AFFINITY—By setting the MP AFFINITY macro, one can enable core-switching, meaning that the OB Executer will alternate between core 0 and core 1 at each cycle. This implements the ping-pong arrangement described above with reference to FIG. 4.

UP AFFINITY—By setting the UP AFFINITY macro, the core-switch operation will be executed, but the OB Executer remains on core 0 only. This macro implements the dedicated cores arrangement described above with reference to FIG. 3.

No macros defined—By not defining any of the above macros, one fully disables the core-switching, meaning that the OB Executer remains on core 0 and no core-switch operations will be executed. This results in operation according to the state of the art execution arrangement described above with reference to FIG. 1.

UP AFFINITY and MP AFFINITY—Setting both macros is un-specified and an invalid configuration.

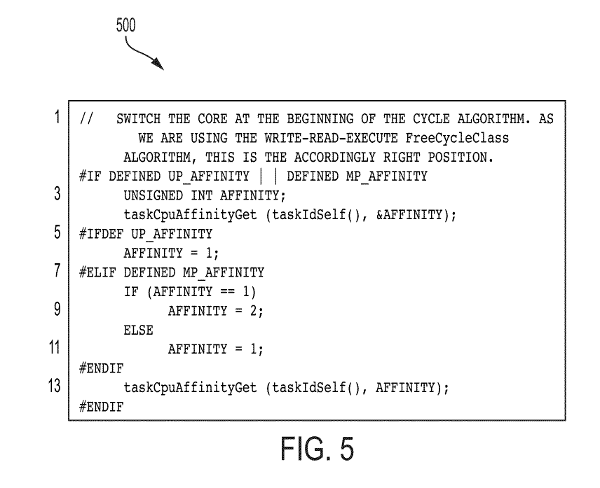

A pseudo-code listing 500 of a method of implementing a core-switching arrangement is shown in FIG. 5. The listing 500 illustrates such an implementation using the vxWorks® operating system.

Optimized Ping-Pong Strategy

The ping-pong strategy described above ensures that the OB Executer occupies a given core only every other cycle. As a consequence, core 0 is available 50% of the time to other WinAC® tasks and a sleep time is no longer necessary to insure that there is available processing time for those tasks. Similarly, core 1 is available 50% of the time to other system tasks. It is furthermore no longer necessary to pin system tasks such as system services to core 1, instead allowing those tasks to run at any time on either one of the cores. That greatly simplifies scheduling and permits the operating system to optimize scheduling of operating system tasks in order to exploit data locality of those tasks. The Execution Monitor, which was used to enforce the sleep periods of the OB Executer task, is also no longer necessary and may be disabled. The OB execution remains a single-threaded process.

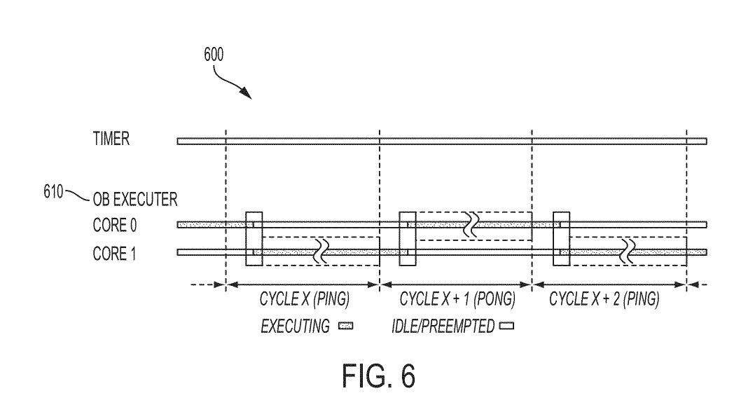

An optimized ping-pong arrangement, in which there are no OB Executer sleep periods, is illustrated by the time sequence 600 of FIG. 6. To implement that strategy, the state-of-the-art OB Executer 610 requires only minor or “surgical” changes: it must be modified to switch cores in each cycle (or every other cycle, etc), and the free-cycle sleep period must be eliminated. The latter modification increases the scan rate of the OB Executer by reducing total cycle time (or increases the throughput per scan). Disabling the Execution Monitor reduces PLC response time. The computational load between the two cores remains balanced, and the processor therefore has an increased expected life.

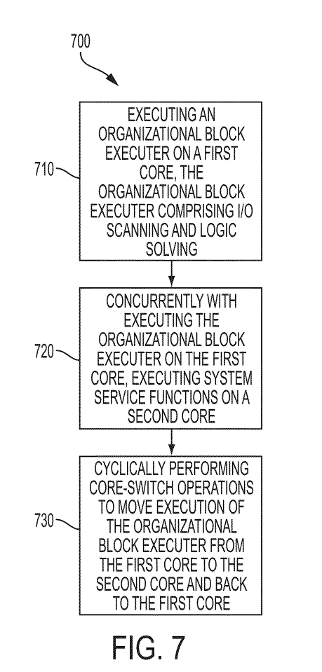

An exemplary method for executing real-time programmable logic controller software on a multicore processor system including at least a first core and a second core, in accordance with the disclosure, is illustrated by the flow chart 700 of FIG. 7. An organizational block executer is initially executing on the first core, at operation 710. The organizational block executer includes I/O scanning and logic solving in a single-threaded execution. Concurrently with executing the organizational block executer on the first core, system service functions associated with the programmable logic controller software are executing on the second core, at operation 720.

Core-switch operations are cyclically performed at operation 730 to move execution of the organizational block executer from the first core to the second core and back to the first core. The system service functions are executed on the second core when the organizational block executer is executing on the first core, and vice versa. As discussed, the organizational block executer may be executed between core switch operations without sleep time.

Performance Evaluation

The optimized embodiments described above have no sleep time, which releases additional computing resources that can be used to increase the throughput. That means that either the frequency of the main cycle OB execution may be increased, or the workload of OB execution may be increased. The first applies when the OB workload remains the same and means that it is possible to execute more OB cycles in the same time period. The latter means that the workload of the main cycle OB may be increased while maintaining the same execution frequency.

Comparing the dedicated cores strategy and the ping-pong strategy, an increase is observed in the overall processor utilization from 89% to 95%, while maintaining good load-balancing with 54% of the workload on core 0 and 46% of the workload on core 1. The execution frequency for the main cycle OB execution described above is approximately the same as the synchronous OB execution.

In comparing the ping-pong strategy and the optimized ping-pong strategy, an increase of the overall workload from 95% to 100% was observed. At the same time the main cycle OB execution frequency increases by 29.5%, which is exactly the ratio of available computing resources considering the synchronous OB execution only. While the overall processor utilization increased only slightly, the execution frequency of the main cycle OB is increased significantly.

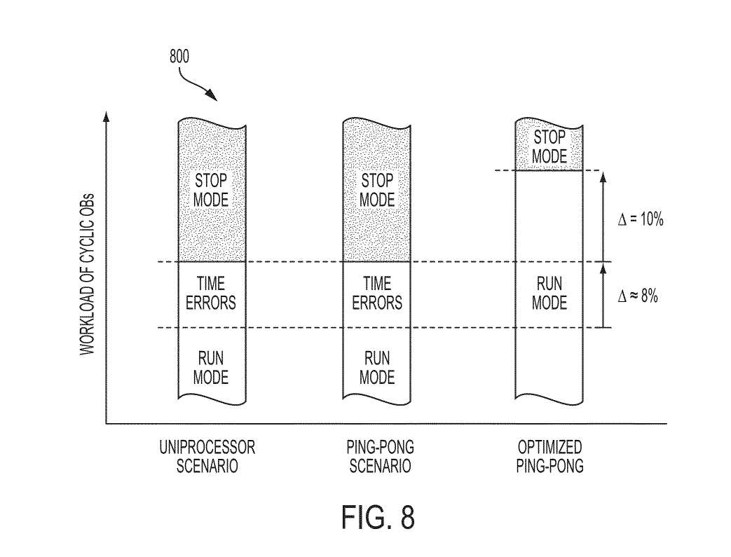

The chart 800 shown in FIG. 8 illustrates that utilization of released computing resources and avoidance of time errors leads to an overall gain of 18% of workload potential. In conclusion, the workload of cyclic OBs can be increased by about 18% using the optimized ping-pong strategy. The benefits arise mainly from disabling the Execution Monitor, as this has the highest impact on asynchronous OB execution.

### CONCLUSION

This disclosed system and method implement a multi-core processor-based application program execution model for PLC system which fully utilizes the two CPUs and achieves best load balancing by executing the OB Executer task on alternating cores. This multi-core based ping-pong execution method can be easily scaled to a system with more than two cores to achieve better load balancing among all the cores.

Although various embodiments that incorporate the teachings of the present invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

What is claimed is:

1. A method for executing real-time programmable logic controller software on a multicore processor system including at least a first core and a second core, comprising:
executing an organizational block executer on the first core, the organizational block executer comprising I/O scanning and logic solving in a single-threaded execution; and
concurrently with executing the organizational block executer on the first core, executing system service functions associated with the programmable logic controller software on the second core.

2. The method of claim 1, wherein the system service functions include a function chosen from the group consisting of a safety function, an HMI function, a software update function, a Web service function and a management function.

3. The method of claim 1, further comprising:
cyclically performing core-switch operations to move execution of the organizational block executer from the first core to the second core and back to the first core;
executing the system service functions on the second core when the organizational block executer is executing on the first core; and
executing the system service functions on the first core when the organizational block executer is executing on the second core.

4. The method of claim 3, wherein the execution of the organizational block executer is a single-threaded execution.

5. The method of claim 3, wherein the execution of the organizational block executer is a single-core execution.

6. The method of claim 3, wherein cyclically performing core-switch operations further comprises:
waking up the organizational block executer from a sleep mode before performing each core-switch operation.

7. The method of claim 3, wherein cyclically performing core-switch operations further comprises:
executing the organizational block executer between core switch operations without sleep time.

8. The method of claim 3, further comprising:
enabling the core-switch operations by executing at least one macro.

9. The method of claim 3,
wherein execution of the organizational block executer comprises cyclically executing READ, EXECUTE and WRITE operations; and
cyclically performing core-switch operations comprises performing the core-switch operations before each READ operation.

10. The method of claim 1, wherein loading between the first and second cores is balanced to within a 10% difference in workload.

11. A programmable logic controller for executing real-time programmable logic controller software, comprising:
a multicore processor having at least a first core and a second core; and
computer readable media connected to the processor and containing computer readable instructions that, when executed by the processor, cause the processor to perform the following operations:
executing an organizational block executer on the first core, the organizational block executer comprising I/O scanning and logic solving in a single-threaded execution; and
concurrently with executing the organizational block executer on the first core, executing system service functions associated with the programmable logic controller software on the second core.

12. The programmable logic controller of claim 11, wherein the system service functions include a function chosen from the group consisting of a safety function, an HMI function, a software update function, a Web service function and a management function.

13. The programmable logic controller of claim 11, wherein the operations further comprise:
cyclically performing core-switch operations to move execution of the organizational block executer from the first core to the second core and back to the first core;
executing the system service functions on the second core when the organizational block executer is executing on the first core; and
executing the system service functions on the first core when the organizational block executer is executing on the second core.

14. The programmable logic controller of claim 13, wherein the execution of the organizational block executer is a single-threaded execution.

15. The programmable logic controller of claim 13, wherein the execution of the organizational block executer is a single-core execution.

16. The programmable logic controller of claim 13, wherein cyclically performing core-switch operations further comprises:
waking up the organizational block executer from a sleep mode before performing each core-switch operation.

17. The programmable logic controller of claim 13, wherein cyclically performing core-switch operations further comprises:
executing the organizational block executer between core switch operations without sleep time.

18. The programmable logic controller of claim 13, wherein the operations further comprise:
enabling the core-switch operations by executing at least one macro.

19. The programmable logic controller of claim 13,
wherein execution of the organizational block executer comprises cyclically executing READ, EXECUTE and WRITE operations; and
cyclically performing core-switch operations comprises performing the core-switch operations before each READ operation.

20. The programmable logic controller of claim 13, wherein loading between the first and second cores is balanced to within a 10% difference in workload.
